(19) United States
(12) Patent Application Publication
(10) Pub. No.: US 2026/0308371 A1
(43) Pub. Date: Oct. 8, 2026

(54) Environment-Friendly Thermoplastic Elastomer Composition and Article Produced Therefrom

(71) Applicant: LOTTE CHEMICAL CORPORATION, Seoul (KR)

(72) Inventors: Won Young CHOI, Uiwang-si (KR); Na Hyeon SHIN, Uiwang-si (KR); Seok Beom SEO, Uiwang-si (KR); Soo Hyun YOON, Uiwang-si (KR); Kyun Ha BAN, Uiwang-si (KR)

(21) Appl. No.: 19/482,867

(22) PCT Filed: May 16, 2024
(86) PCT No.: PCT/KR2024/006665

§ 371 Date: Nov. 10, 2025

(30) Foreign Application Priority Data
May 31, 2023 (KR) 10-2023-0069885

(51) Int. Cl. C08L 53/02; C08L 91/00

(52) U.S. Cl. CPC C08L 53/02; C08L 91/00; C08L 2205/03; C08L 2207/04; C08L 2207/322

(57) ABSTRACT

The thermoplastic elastomer composition of the present invention comprises: about 100 parts by weight of a thermoplastic elastomer; about 3 to about 25 parts by weight of a polyolefin resin; about 50 to about 200 parts by weight of a vegetable oil having the thermal decomposition onset temperature of about 325 to about 365° C.; and about 5 to about 30 parts by weight of an inorganic filler. The thermoplastic elastomer composition exhibits excellent environmentally friendliness, thermal decomposition stability, moldability, slip properties, and low hardness characteristics, and enables the reduction of unpleasant odors.

### TECHNICAL FIELD

The present invention relates to an environment-friendly thermoplastic elastomer composition and a molded article formed of the same. More particularly, the present invention relates to a thermoplastic elastomer composition that has good properties in terms of environment-friendliness, thermal decomposition stability, moldability, slipperiness, low hardness, and the like, while ensuring reduction of unpleasant odors, and a molded article formed of the same.

### BACKGROUND ART

Unlike solid rubber, a thermoplastic elastomer (TPE) is cross-linked physically, rather than chemically, and shows solid rubber-like elasticity at ambient temperature while retaining the ability to be freely processed through extrusion and injection molding. Under normal conditions, long molecules that make up the thermoplastic elastomer are irregularly coiled and, when tensile force is applied to the thermoplastic elastomer, the long molecules stretch in the direction in the force acts. Then, upon removal of the applied tensile force, the molecules rapidly return to their original, disordered arrangement. Due to the advantages of thermoplastic elastomers, such as easy processability and elastic restorability, demand therefor as a substitute for non-reusable rubber has rapidly increased, leading to development of a wide range of related products. For example, thermoplastic elastomers can be used in various applications, such as building gaskets, automotive parts, handgrips, hoses, cushioning materials, and wire insulators.

Incorporation of a petroleum-derived mineral oil, such as paraffin oil, into a thermoplastic elastomer composition facilitates adjustment of properties of the composition, such as hardness, moldability, compression set (C.Set), and the like. However, such a mineral oil can cause reduction in environment-friendliness, generation of unpleasant odors, and defects in appearance, and the like.

Therefore, there is a need for a thermoplastic elastomer composition that has good properties in terms of environment-friendliness, thermal decomposition stability, moldability, slipperiness, low hardness, and the like, while ensuring reduction of unpleasant odors.

The background technique of the present invention is disclosed in Korean Laid-open Publication No. 10-2016-0114994 and the like.

### DISCLOSURE

### Technical Problem

It is an object of the present invention to provide a thermoplastic elastomer composition that has good properties in terms of environment-friendliness, thermal decomposition stability, moldability, slipperiness, and low hardness, and the like, while ensuring reduction of unpleasant odors.

It is another object of the present invention to provide a molded article formed of the thermoplastic elastomer composition set forth above.

The above and other objects of the present invention will become apparent from the detailed description of the following embodiments.

### Technical Solution

1. One aspect of the present invention relates to a thermoplastic elastomer composition. The thermoplastic elastomer composition comprises: about 100 parts by weight of a thermoplastic elastomer; about 3 parts by weight to about 25 parts by weight of a polyolefin resin; about 50 parts by weight to about 200 parts by weight of a vegetable oil having a thermal decomposition onset temperature of about 325° C. to about 365° C.; and about 5 parts by weight to about 30 parts by weight of inorganic fillers.

2. In embodiment 1, the thermoplastic elastomer may have a weight average molecular weight of about 100,000 g/mol to about 450,000 g/mol.

3. In embodiment 1 or 2, the polyolefin resin may comprise at least one of: polypropylene; a random copolymer obtained by polymerizing two or more monomers selected from among propylene, ethylene, butylene, and octene; a block copolymer in which ethylene-propylene rubber is blended with polypropylene; polyethylene; an ethylene-vinyl acetate copolymer; and a copolymer of an α-olefin.

4. In embodiments 1 to 3, the polyolefin resin may have a weight average molecular weight of about 100,000 g/mol to about 550,000 g/mol.

5. In embodiments 1 to 4, the polyolefin resin may have a melt-flow index of about 0.5 g/10 min to about 40 g/10 min, as measured at a temperature of 190° C. under a load of 2.16 kg in accordance with ASTM D1238.

6. In embodiments 1 to 5, the vegetable oil may comprise at least one of olive oil, canola oil, and grape seed oil.

7. In embodiments 1 to 6, the inorganic fillers may comprise at least one of talc, calcium carbonate, clay, wollastonite, mica, whiskers, and glass fibers.

8. In embodiments 1 to 7, the thermoplastic elastomer composition may have a thermal decomposition onset temperature of about 387° C. to about 413° C., as measured by thermogravimetric analysis.

9. In embodiments 1 to 8, the thermoplastic elastomer composition may have a melt-flow index of about 15 g/10 min to about 50 g/10 min, as measured at a temperature of 230° C. under a load of 5 kgf in accordance with ISO 1133.

10. In embodiments 1 to 9, the thermoplastic elastomer composition may have a tackiness of about 0.05 to about 0.30, as measured using a scratch resistance tester.

11. In embodiments 1 to 10, the thermoplastic elastomer composition may have a Shore A hardness of about 30 to about 70, as measured on a stack of three 2 mm thick specimens using a Shore A durometer in accordance with ISO 868.

12. In embodiments 1 to 11, the thermoplastic elastomer composition may have an odor rating of 7 to 8, as measured according to the odor test method of GEELY AUTO.

13. Another aspect of the present invention relates to a molded article. The molded article is formed of the thermoplastic elastomer composition according to any one of embodiments 1 to 12.

### Advantageous Effects

Embodiments of the present invention provide a thermoplastic elastomer composition that has good properties in terms of environment-friendliness, thermal decomposition stability, moldability, slipperiness, low hardness, and the like, while ensuring reduction of unpleasant odors, and a molded article formed of the same.

### BEST MODE

Hereinafter, embodiments of the present invention will be described in detail.

A thermoplastic elastomer composition according to the present invention comprises: (A) a thermoplastic elastomer; (B) a polyolefin resin; (C) a vegetable oil; and (D) inorganic fillers.

As used herein to represent a specific numerical range, “a to b” means “a≤ and ≤b”.

### (A) Thermoplastic Elastomer

The thermoplastic elastomer according to one embodiment of the invention serves to improve properties of the thermoplastic elastomer composition, such as environment-friendliness, thermal decomposition stability, moldability, slipperiness, low hardness, and the like, as well as reducing unpleasant odors, without sacrificing mechanical performance of the thermoplastic elastomer composition, when used in combination with the polyolefin resin, the specific vegetable oil, and the inorganic fillers, and may include a styrene-based thermoplastic elastomer, an amide-based thermoplastic elastomer, a urethane-based thermoplastic elastomer, an ester-based thermoplastic elastomer, and the like, which are used in typical thermoplastic elastomer compositions. Preferably, the thermoplastic elastomer includes a styrene-based thermoplastic elastomer, such as a styrene-ethylene/butylene-styrene (SEBS) copolymer and the like.

In some embodiments, the thermoplastic elastomer may have a weight average molecular weight of about 100,000 g/mol to about 450,000 g/mol, for example, about 150,000 g/mol to about 400,000 g/mol, as measured by gel permeation chromatography (GPC). Within this range, the thermoplastic elastomer composition can have good properties in terms of mechanical performance, elastic restorability, and the like.

### (B) Polyolefin Resin

The polyolefin resin according to one embodiment of the invention serves to improve properties of the thermoplastic elastomer composition, such as environment-friendliness, thermal decomposition stability, moldability, slipperiness, low hardness characteristics, and the like, as well as reducing unpleasant odors, without sacrificing mechanical performance of the thermoplastic elastomer composition, when used in combination with the thermoplastic elastomer, the specific vegetable oil, and the inorganic fillers, and may include a polyolefin resin used in typical thermoplastic elastomer compositions.

In some embodiments, the polyolefin resin may include: polypropylene; a random copolymer obtained by polymerization of two or more monomers selected from among propylene, ethylene, butylene, and octene; a block copolymer in which ethylene-propylene rubber is blended with polypropylene; polyethylene; an ethylene-vinyl acetate copolymer; a copolymer of an α-olefin; and combinations thereof.

In some embodiments, the polyolefin resin may have a weight average molecular weight of about 100,000 g/mol to about 550,000 g/mol, for example, about 150,000 g/mol to about 500,000 g/mol, as measured by GPC. Within this range, the thermoplastic elastomer composition can have good properties in terms of mechanical performance, elastic restorability, and the like.

In some embodiments, the polyolefin resin may have a melt-flow index of about 0.5 g/10 min to about 40 g/10 min, for example, about 0.8 g/10 min to about 40 g/10 min, as measured at a temperature of 190° C. under a load of 2.16 kg in accordance with ASTM D1238. Within this range, the thermoplastic elastomer composition can have good properties in terms of moldability and the like.

In some embodiments, the polyolefin resin may be present in an amount of about 3 parts by weight to about 25 parts by weight, for example, about 5 parts by weight to about 20 parts by weight, relative to about 100 parts by weight of the thermoplastic elastomer. If the content of the polyolefin resin is less than about 3 parts by weight relative to about 100 parts by weight of the thermoplastic elastomer, the thermoplastic elastomer composition can fail to reduce unpleasant odors while having poor properties in terms of moldability, slipperiness, and the like, whereas, if the content of the polyolefin resin exceeds about 25 parts by weight relative to about 100 parts by weight of the thermoplastic elastomer, the thermoplastic elastomer composition can suffer from deterioration in workability (controllability over molding conditions) due to excessive increase in melt-flow index, while having poor properties in terms of thermal decomposition stability, slipperiness, and the like.

### (C) Vegetable Oil

The vegetable oil according to one embodiment of the invention is an environment-friendly material and serves to improve properties of the thermoplastic elastomer composition, such as environment-friendliness, thermal decomposition stability, moldability, slipperiness, low hardness, and the like, as well as reducing unpleasant odors, without sacrificing mechanical performance of the thermoplastic elastomer composition, when used in combination with the thermoplastic elastomer, the polyolefin resin, and the inorganic fillers. The vegetable oil may include a plant-derived vegetable oil having a thermal decomposition temperature of about 325° C. to about 365° C.

In some embodiments, the vegetable oil may have a thermal decomposition temperature of about 325° C. to about 365° C., for example, about 325° C. to about 360° C., as measured by thermogravimetric analysis (TGA) over a temperature range of 30° C. to 850° C. at a heating rate of 20° C./min under a nitrogen (N₂) atmosphere. If the thermal decomposition temperature of the vegetable oil is less than about 325° C., the thermoplastic elastomer composition can fail to reduce unpleasant odors while having poor properties in terms of thermal decomposition stability, moldability, and/or slipperiness, whereas, if the thermal decomposition temperature of the vegetable oil exceeds about 365° C., the thermoplastic elastomer composition can have poor properties in terms of compatibility, moldability, and the like.

In some embodiments, the vegetable oil may include olive oil, canola oil, grape seed oil, and combinations thereof.

In some embodiments, the vegetable oil may have a kinematic viscosity of about 90 cSt to about 180 cSt, for example, about 100 cSt to about 160 cSt, as measured at 40° C. in accordance with ASTM D445. Within this range, the thermoplastic elastomer composition can have good properties in terms of processability, flexibility, and the like.

In some embodiments, the vegetable oil may be present in an amount of about 50 parts by weight to about 200 parts by weight, for example, 100 parts by weight to 150 parts by weight, relative to about 100 parts by weight of the thermoplastic elastomer. If the content of the vegetable oil is less than about 50 parts by weight relative to about 100 parts by weight of the thermoplastic elastomer, the thermoplastic elastomer composition can fail to reduce unpleasant odors while having poor properties in terms of environment-friendliness, thermal decomposition stability, moldability, slipperiness, and the like, whereas, if the content of the vegetable oil exceeds about 200 parts by weight relative to about 100 parts by weight of the thermoplastic elastomer, the thermoplastic elastomer composition can have poor properties in terms of slipperiness, workability (controllability over molding conditions), and the like.

In some embodiments, a weight ratio of the polyolefin resin to the vegetable oil may range from about 1:4 to about 1:50, for example, about 1:5 to about 1:20. Within this range, the thermoplastic elastomer composition can have further improved properties in terms of slipperiness, low hardness, and the like.

### (D) Inorganic Fillers

The inorganic fillers according to one embodiment of the invention serves to improve properties of the thermoplastic elastomer composition, such as environment-friendliness, thermal decomposition stability, moldability, slipperiness, low hardness, and the like, as well as reducing unpleasant odors, without sacrificing mechanical performance of the thermoplastic elastomer composition, when used in combination with the thermoplastic elastomer, the polyolefin resin, and the specific vegetable oil and may include inorganic fillers used in typical thermoplastic elastomer compositions.

In some embodiments, the inorganic fillers may include talc, calcium carbonate, clay, wollastonite, mica, whiskers, glass fibers, and combinations thereof. For example, the inorganic fillers may include talc, calcium carbonate, and combinations thereof, without being limited thereto.

In some embodiments, the inorganic fillers may have an average particle size (D50) of about 1.5 μm to about 3.5 μm, for example, about 1.65 μm to about 3.5 μm, as measured by a particle size analyzer (Malvern Mastersizer 3000), a moisture regain of about 0.3% or less, and a specific surface area of about 11,500 cm³/g to about 13,500 cm³/g. Within these ranges, the thermoplastic elastomer composition can have good properties in terms of slipperiness, low hardness, and the like.

In some embodiments, the inorganic fillers may be present in an amount of about 5 parts by weight to about 30 parts by weight, for example, about 10 parts by weight to 25 parts by weight, relative to about 100 parts by weight of the thermoplastic elastomer. If the content of the inorganic fillers is less than about 5 parts by weight relative to about 100 parts by weight of the thermoplastic elastomer, the thermoplastic elastomer composition can have poor properties in slipperiness, workability (controllability over molding conditions), and the like, whereas, if the content the inorganic fillers exceeds about 30 parts by weight relative to about 100 parts by weight of the thermoplastic elastomer, the thermoplastic elastomer composition can have poor properties in terms of moldability, slipperiness, low hardness, and the like.

In some embodiments, a weight ratio of the polyolefin resin to the inorganic fillers may range from about 1:0.4 to about 1:5, for example, about 1:0.6 to about 1:3. Within this range, the thermoplastic elastomer composition can have further improved properties in terms of moldability, low hardness, and the like.

In some embodiments, a weight ratio of the vegetable oil to the inorganic fillers may range from about 1:0.05 to about 1:0.5, for example, about 1:0.1 to about 1:0.25. Within this range, the thermoplastic elastomer composition can have further improved properties in terms of moldability, low hardness, and the like.

The thermoplastic elastomer composition according to one embodiment of the invention may further include additives used in typical thermoplastic elastomer compositions. Examples of the additives may include antioxidants, flame retardants, anti-dripping agents, heat stabilizers, slip agents, and mixtures thereof, without being limited thereto. When the additives are used, the additives may be present in an amount of about 0.001 parts by weight to about 40 parts by weight, for example, about 0.1 parts by weight to about 10 parts by weight, relative to about 100 parts by weight of the thermoplastic elastomer.

The thermoplastic elastomer composition according to one embodiment of the invention may be prepared in pellet form by mixing the aforementioned components, followed by melt extrusion in a typical twin-screw extruder at a temperature of about 150° C. to about 250° C., for example, about 170° C. to about 230° C.

In some embodiments, the thermoplastic elastomer composition is environment-friendly, with the content of the environment-friendly material (vegetable oil) being about 50 parts by weight or more, for example, about 100 parts by weight or more, relative to about 100 parts by weight of the thermoplastic elastomer.

In some embodiments, the thermoplastic elastomer composition may have a thermal decomposition onset temperature of about 387° C. to about 413° C., for example, about 390° C. to about 410° C., as measured by thermogravimetric analysis (TGA) over a temperature range of 30° C. to 850° C. at a heating rate of 20° C./min under a nitrogen (N₂) atmosphere.

In some embodiments, the thermoplastic elastomer composition may have a melt-flow index of about 15 g/10 min to about 50 g/10 min, for example, about 15 g/10 min to about 45 g/10 min, as measured at a temperature of 230° C. under a load of 5 kgf in accordance with ISO 1133.

In some embodiments, the thermoplastic elastomer composition may have a tackiness of about 0.05 to about 0.30, for example, about 0.05 to about 0.25, as measured using a scratch resistance tester.

In some embodiments, the thermoplastic elastomer composition may have a Shore A hardness of about 30 to about 70, for example, about 30 to about 60, as measured on a stack of three 2 mm thick specimens using a Shore A durometer. If the Shore A hardness of the thermoplastic elastomer composition falls outside this range, the thermoplastic elastomer composition can be unsuitable for the purpose of the invention due to the lack of appropriate elasticity.

In some embodiments, the thermoplastic elastomer composition may have an odor rating of 7 to 8, as measured by the odor test method of GEELY AUTO.

A molded article according to the present invention is formed of the thermoplastic elastomer composition set forth above. The thermoplastic elastomer composition may be prepared in pellet form. The prepared pellets may be produced into various molded articles (products) by various molding methods, such as injection molding, extrusion, vacuum molding, casting, and the like. Such molding methods are well known to a person having ordinary skill in the art to which the present invention pertains. The molded article is useful as a material for sealing parts, shock-absorbing parts, and the like, particularly building gaskets, automotive interior parts, and tool grips, due to good properties thereof in terms of environment-friendliness, thermal decomposition stability, moldability, slipperiness, low hardness, odor reduction, and the like.

### MODE FOR INVENTION

Next, the present invention will be described in more detail with reference to some examples. However, it should be noted that these examples are provided for illustration only and are not to be construed in any way as limiting the present invention.

### Example

Details of components used in Examples and Comparative Examples are as follows:

### (A) Thermoplastic Elastomer

A styrene-ethylene/butylene-styrene (SEBS) copolymer (weight average molecular weight: about 350,000 g/mol, product name: G1651, manufacturer: Kraton Corp.) was used.

### (B) Polyolefin Resin

A polypropylene resin (random copolymer, weight average molecular weight: about 450,000 g/mol, melt-flow index (at 190° C. under a load of 2.16 kg): about 1 g/10 min, product name: SB-520, manufacturer: Lotte Chemical) was used.

### (C) Oil

(C1) Canola oil (thermal decomposition onset temperature: about 355° C., manufacturer: Lotte Confectionery) was used.

(C2) Olive oil (thermal decomposition onset temperature: about 333° C., manufacturer: Lotte Confectionery) was used.

(C3) Grape seed oil (thermal decomposition onset temperature: about 329° C., manufacturer: Lotte Confectionery) was used.

(C4) Paraffin oil (thermal decomposition onset temperature: about 230° C., product name: W-1900H, manufacturer: MiChang Oil Ind.) was used.

(C5) Castor oil (thermal decomposition onset temperature: about 324° C., product name: Castor oil, manufacturer: GIRNAR Ind.) was used.

(D) Inorganic fillers

Calcium carbonate (product name: CMS-8000, manufacturer: KOCH) was used.

### Examples 1 to 8 and Comparative Examples 1 and 8

The aforementioned components were mixed in amounts as listed in Tables 1, 2, 3, 4, and 5, followed by extrusion at a barrel temperature of about 220° C., thereby preparing a thermoplastic elastomer composition in pellet form. Here, extrusion was performed using a twin-screw extruder (L/D: 36, diameter: 45 mm). The prepared pellets were dried at 100° C. for 4 hours or more, followed by injection molding using a 150-ton injection molding machine (cylinder temperature: about 200° C., mold temperature: about 40° C.), thereby preparing specimens. The prepared specimens were evaluated as to the following properties. Results are shown in Tables 2, 3, 4, and 5.

### Property Evaluation

(1) Thermal decomposition stability (unit: ° C.): Thermal decomposition onset temperature was measured by thermogravimetric analysis (TGA) over a temperature range of 30° C. to 850° C. at a heating rate of 20° C. under a nitrogen (N₂) atmosphere using a TGA instrument (pan type: aluminum oxide (Al₂O₃) crucible, model name: Q5000, manufacturer: TA Instruments). A higher thermal decomposition onset temperature indicates better thermal decomposition stability.

(2) Moldability (unit: g/10 min): Melt-flow index (MFI) was measured at a temperature of 230° C. under a load of 5 kgf in accordance with ISO 1133. A higher melt-flow index indicates better moldability.

(3) Slipperiness: Tackiness was calculated according to Equation 1.

Tackiness(μ)=Static coefficient of friction(μs)−Kinetic coefficient of friction(μk) [Equation 1]

In Equation 1, the static coefficient of friction and kinetic coefficient of friction were measured on a flat specimen having a size of 2 mm×50 mm×150 mm by pressing an indenter having an aluminum tip (R-processed tip, diameter: 4 mm) against the specimen under a load of 0.5 kgf, followed by moving the indenter at a speed of 100 mm/sec, using a scratch resistance tester (model name: type 18L, manufacturer: Heidon). The static coefficient of friction was defined as a coefficient of friction measured from the force applied to the indenter while stationary, and the kinetic coefficient of friction was defined as a coefficient of friction measured from the force applied to the indenter while moving. A lower tackiness indicates better slipperiness.

(4) Hardness: Shore A hardness was measured on a stack of three 2 mm thick specimens using a Shore A durometer in accordance with ISO 868.

(5) Odor level (unit: rating score): 100 g of a specimen of the thermoplastic elastomer composition in pellet form was evaluated as to odor level in accordance with Q/JLY J7110538C (odor test standard of GEELY AUTO). Five trained assessors, each experienced with at least 10 evaluations based on this standard, rated the odor of the specimen according to the criteria in Table 1, followed by averaging assessments of the assessors, including decimals, thereby obtaining a final odor rating. As shown in Table 1, a lower odor rating indicates the presence of a more unpleasant odor.

TABLE 1

| | | Sensations |
|---|---|---|
| Odor | | perceived by |
| rating | Details | humans |
| 10 | No odor | Pleasant |
| 9 | Barely perceptible, difficult to identify the | |
| | type of odor | |
| 8 | Presence of odor is detected; slightly pleasant | |
| 7 | Odor is not pungent and clearly detectable | Distinctly |
| 6 | Odor is slightly pungent and clearly detectable | pungent but |
| | | bearable |
| 5 | Odor is moderately pungent and clearly detectable | Somewhat |
| 4 | Unpleasant odor; slightly less offensive | irritating and |
| | | unbearable |
| 3 | Pungent odor; offensive | Unbearable |
| 2 | Pungent odor; very offensive | irritation and |
| 1 | Stifling and unbearable odor | nausea |

TABLE 2

| | Example | | | |
|---|---|---|---|---|
| | 1 | 2 | 3 | 4 |
| (A) (parts by weight) | 100 | 100 | 100 | 100 |
| (B) (parts by weight) | 20 | 20 | 20 | 20 |
| (C1) (parts by weight) | 100 | 150 | — | — |
| (C2) (parts by weight) | — | — | 100 | — |
| (C3) (parts by weight) | — | — | — | 100 |
| (C4) (parts by weight) | — | — | — | — |
| (C5) (parts by weight) | — | — | — | — |
| (D) (parts by weight) | 15 | 15 | 15 | 15 |
| Thermal decomposition | 405 | 410 | 402 | 395 |
| onset temperature | | | | |
| Melt-flow index | 30 | 35 | 34 | 34 |
| Tackiness | 0.13 | 0.10 | 0.23 | 0.17 |
| Shore A hardness | 44 | 33 | 49 | 51 |
| Odor rating | 7 | 8 | 7 | 7 |

TABLE 3

| | Example | | | |
|---|---|---|---|---|
| | 5 | 6 | 7 | 8 |
| (A) (parts by weight) | 100 | 100 | 100 | 100 |
| (B) (parts by weight) | 5 | 15 | 15 | 15 |
| (C1) (parts by weight) | 100 | 100 | 100 | 100 |
| (C2) (parts by weight) | — | — | — | — |
| (C3) (parts by weight) | — | — | — | — |
| (C4) (parts by weight) | — | — | — | — |
| (C5) (parts by weight) | — | — | — | — |
| (D) (parts by weight) | 15 | 15 | 10 | 25 |
| Thermal decomposition | 410 | 390 | 390 | 390 |
| onset temperature | | | | |
| Melt-flow index | 15 | 28 | 32 | 15 |
| Tackiness | 0.10 | 0.18 | 0.20 | 0.08 |
| Shore A hardness | 43 | 55 | 45 | 53 |
| Odor rating | 7 | 7 | 7 | 7 |

TABLE 4

| | Comparative Example | | | |
|---|---|---|---|---|
| Table 4 | 1 | 2 | 3 | 4 |
| (A) (parts by weight) | 100 | 100 | 100 | 100 |
| (B) (parts by weight) | 1 | 30 | 20 | 20 |
| (C1) (parts by weight) | 100 | 100 | 40 | 210 |
| (C2) (parts by weight) | — | — | — | — |
| (C3) (parts by weight) | — | — | — | — |
| (C4) (parts by weight) | — | — | — | — |
| (C5) (parts by weight) | — | — | — | — |
| (D) (parts by weight) | 15 | 15 | 15 | 15 |
| Thermal | 413 | 375 | 380 | 420 |
| decomposition onset | | | | |
| temperature | | | | |
| Melt-flow index | 12 | 55 | 13 | 55 |
| Tackiness | 0.36 | 0.32 | 0.47 | 0.39 |
| Shore A hardness | 33 | 62 | 64 | 42 |
| Odor rating | 6 | 7 | 6 | 8 |

TABLE 5

| | Comparative Example | | | |
|---|---|---|---|---|
| | 5 | 6 | 7 | 8 |
| (A) (parts by weight) | 100 | 100 | 100 | 100 |
| (B) (parts by weight) | 20 | 20 | 20 | 20 |
| (C1) (parts by weight) | — | — | 100 | 100 |
| (C2) (parts by weight) | — | — | — | — |
| (C3) (parts by weight) | — | — | — | — |
| (C4) (parts by weight) | 100 | — | — | — |
| (C5) (parts by weight) | — | 100 | — | — |
| (D) (parts by weight) | 15 | 15 | 1 | 35 |
| Thermal | 383 | 385 | 405 | 405 |
| decomposition onset | | | | |
| temperature | | | | |
| Melt-flow index | 28 | 13 | 60 | 13 |
| Tackiness | 0.33 | 0.52 | 0.43 | 0.49 |
| Shore A hardness | 50 | 57 | 31 | 71 |
| Odor rating | 4 | 4 | 7 | 7 |

From the above results, it could be seen that the thermoplastic elastomer compositions according to the present invention exhibited good properties in terms of environment-friendliness, thermal decomposition stability (thermal decomposition onset temperature), moldability (melt-flow index), slipperiness (tackiness), low hardness (Shore A hardness), and the like, while ensuring reduction of unpleasant odors.

Conversely, it could be seen that the thermoplastic elastomer composition according to Comparative Example 1, prepared using an insufficient amount of the polyolefin resin, failed to reduce unpleasant odors while exhibiting poor properties in terms of moldability, slipperiness, and the like; and the thermoplastic elastomer composition according to Comparative Example 2, prepared using an excess of the polyolefin resin, exhibited poor properties in terms of thermal decomposition stability, slipperiness, and the like and had an excessively high melt-flow index, making it difficult to control molding conditions. In addition, it could be seen that the thermoplastic elastomer composition according to Comparative Example 3, prepared using an insufficient amount of the vegetable oil, failed to reduce unpleasant odors while exhibiting poor properties in terms of environment-friendliness, thermal decomposition stability, moldability, slipperiness, and the like; the thermoplastic elastomer composition according to Comparative Example 4, prepared using an excess of the vegetable oil, exhibited poor properties in terms of slipperiness and the like and had an excessively high melt-flow index; the thermoplastic elastomer composition according to Comparative Example 5, prepared using paraffin oil C4, the thermal decomposition onset temperature of which was less than the range according to the present invention, instead of the vegetable oil according to the present invention, failed to reduce unpleasant odors while exhibiting poor properties in terms of thermal decomposition stability, slipperiness, and the like; and the thermoplastic elastomer composition according to Comparative Example 6, prepared using castor oil C5, the thermal decomposition onset temperature of which was less than the range according to the present invention, failed to reduce unpleasant odors while exhibiting poor properties in terms of thermal decomposition stability, moldability, slipperiness, and the like. In addition, it could be seen that the thermoplastic elastomer composition according to Comparative Example 7, prepared using an insufficient amount of the inorganic fillers, exhibited poor properties in terms of slipperiness and the like and had an excessively high melt-flow index; and the thermoplastic elastomer composition according to Comparative Example 8, prepared using an excess of the inorganic fillers, exhibited poor properties in terms of moldability, slipperiness, low hardness, and the like.

Although some embodiments have been described herein, it will be understood by those skilled in the art that various modifications, changes, and alterations can be made without departing from the spirit and scope of the invention. Therefore, it should be understood that these embodiments are provided for illustration only and are not to be construed in any way as limiting the present invention. The scope of the present invention should be defined by the appended claims rather than by the foregoing description, and the claims and equivalents thereto are intended to cover such modifications and the like as would fall within the scope of the present invention.

1. A thermoplastic elastomer composition comprising:
about 100 parts by weight of a thermoplastic elastomer;
about 3 parts by weight to about 25 parts by weight of a polyolefin resin;
about 50 parts by weight to about 200 parts by weight of a vegetable oil having a thermal decomposition onset temperature of about 325° C. to about 365° C.; and
about 5 parts by weight to about 30 parts by weight of inorganic fillers.

2. The thermoplastic elastomer composition according to claim 1, wherein the thermoplastic elastomer has a weight average molecular weight of about 100,000 g/mol to about 450,000 g/mol.

3. The thermoplastic elastomer composition according to claim 1, wherein the polyolefin resin comprises at least one of: polypropylene; a random copolymer obtained by polymerizing two or more monomers selected from among propylene, ethylene, butylene, and octene; a block copolymer in which ethylene-propylene rubber is blended with polypropylene; polyethylene; an ethylene-vinyl acetate copolymer; and a copolymer of an α-olefin.

4. The thermoplastic elastomer composition according to claim 1, wherein the polyolefin resin has a weight average molecular weight of about 100,000 g/mol to about 550,000 g/mol.

5. The thermoplastic elastomer composition according to claim 1, wherein the polyolefin resin has a melt-flow index of about 0.5 g/10 min to about 40 g/10 min, as measured at a temperature of 190° C. under a load of 2.16 kg in accordance with ASTM D1238.

6. The thermoplastic elastomer composition according to claim 1, wherein the vegetable oil comprises at least one of olive oil, canola oil, and grape seed oil.

7. The thermoplastic elastomer composition according to claim 1, wherein the inorganic fillers comprise at least one of talc, calcium carbonate, clay, wollastonite, mica, whiskers, and glass fibers.

8. The thermoplastic elastomer composition according to claim 1, wherein the thermoplastic elastomer composition has a thermal decomposition onset temperature of about 387° C. to about 413° C., as measured by thermogravimetric analysis.

9. The thermoplastic elastomer composition according to claim 1, wherein the thermoplastic elastomer composition has a melt-flow index of about 15 g/10 min to about 50 g/10 min, as measured at a temperature of 230° C. under a load of 5 kgf in accordance with ISO 1133.

10. The thermoplastic elastomer composition according to claim 1, wherein the thermoplastic elastomer composition has a tackiness of about 0.05 to about 0.30, as measured using a scratch resistance tester.

11. The thermoplastic elastomer composition according to claim 1, wherein the thermoplastic elastomer composition has a Shore A hardness of about 30 to about 70, as measured on a stack of three 2 mm thick specimens using a Shore A durometer in accordance with ISO 868.

12. The thermoplastic elastomer composition according to claim 1, wherein the thermoplastic elastomer composition has an odor rating of 7 to 8, as measured according to the odor test method of GEELY AUTO.

13. A molded article formed of the thermoplastic elastomer composition according to claim 1.
